(19) United States
(12) Patent Application Publication
(10) Pub. No.: US 2026/0241603 A1
(43) Pub. Date: Aug. 20, 2026

(54) METHOD FOR FORMING PORTIONS

(71) Applicant: Weber Food Technology SE & CO. KG, Breidenbach (DE)

(72) Inventors: Gerd Lischinski, Schonbeck (DE); Sigfrid Bauer, GroB Teetzleben (DE); Markus Haas, Haiger (DE); Matthias Salmen, Wiggensbach (DE)

(21) Appl. No.: 19/156,962

(22) PCT Filed: Feb. 16, 2024
(86) PCT No.: PCT/EP2024/054025

§ 371 Date: Oct. 13, 2025

(30) Foreign Application Priority Data
Feb. 17, 2023 (DE) 10 2023 103 977.6

(51) Int. Cl. B26D 7/32; B26D 5/32; B26D 7/06; B26D 7/30

(52) U.S. Cl. CPC B26D 7/32; B26D 5/32; B26D 7/0625; B26D 7/30; B26D 2210/02

(57) ABSTRACT

The invention relates to a method for forming portions that each comprise a number of n (n≥1) slices that are obtained by a single-track or multitrack slicing of loaf-shaped or strand-shaped food products by means of a slicing apparatus, in particular a high-speed slicer, wherein, in the method, the changing of a feed speed of the product conveying device is controlled by means of a computer program that, during the slicing of each product, is executed without a program change for the entire product, including the product start and the product end, in a processor of the control device.

### RELATED APPLICATION

The present application is a national stage application under 35 U.S.C. § 371 of International Application No. PCT/EP 2024/054025, filed 16 Feb. 2024, which claims priority from German Patent Application No. 10 2023 103 977.6, filed 17 Feb. 2023. The above-referenced applications are incorporated by reference.

### SUMMARY

The invention relates to a method for forming portions that each comprise a number of n (n≥1) slices that are obtained by a single-track or multitrack slicing of loaf-shaped or strand-shaped food products by means of a slicing apparatus, in particular a high-speed slicer, having the further features of the preamble of claim 1. Furthermore, the invention relates to a slicing apparatus having the features of claim 12 that is configured to carry out the method according to the invention.

Such methods and apparatus are generally known, for example, from DE 10 2009 036 682 A1 that mentions further patent literature for this technical field.

When slicing food, the main focus is usually on the visual quality and the predefined weight of the obtained slices or of the portions formed therefrom. A speed optimization such that the slicing takes place as quickly as possible without compromising quality is usually of less importance in comparison.

A contour detection, i.e. the detection of the external shape of the products, can in particular take place with a scanning device that has one or more laser scanners and that operates in accordance with the so-called light sectioning method that is generally known to the skilled person in the present technical field and is therefore not explained in more detail here.

Alternatively or additionally, it is also possible to detect the structure of the products, i.e. to obtain information about the product inside, in order, in this way, to be able to consider density inhomogeneities—for example hollow spaces in cheese products—in the portion planning. For such a structure detection, X-ray scanners, which are used in conjunction with high-speed slicers, are known in the present technical field. Due to the structure detection, an individual value for the product density can consequently be determined for each product if the individual product weight is furthermore determined.

In addition, the weight of each food product can be determined for the portion planning by weighing. An average value for the product density can then be determined for each product from the volume obtained by the contour detection and from the measured weight. However, it is also known to work with an average value for the density without weighing the products, said average value, for example, being based on assumptions or empirical values and thus being taken from existing data. By means of so-called “end-of-line” scales, which determine the weight of the fully formed, in particular already packaged portions, a density value can also be obtained over a comparatively long period of time and can be used for the checking and can, if necessary, also be corrected. Since the weight of the packaging itself, i.e. the weight without contents, is known and practically constant, this weight can be subtracted from the weight value determined by means of the scale and the weight of the respective packaged portion, i.e. the contents, can thus be determined. To this end, control loops with different speeds are generally known. In a comparatively fast control loop, the value for the average density is, for example, also changed after a batch change in dependence on the respective product type (e.g. more fat-heavy or leaner). With a relatively slow control loop, for example, an overweight of the portions can initially be generated in a targeted manner, whereupon an approximation to the desired weight of the individual portions takes place.

The desired properties of the portions to be formed can vary from application to application. For example, it may be required that each portion has the same number of slices. Alternatively, it may be required that all the slices of a portion have the same slice thickness. This inter alia has the advantage from the point of view of the end consumer that when frying, for example, slices of bacon, they are all done at the same time and the thinnest slice is not already “burnt” when the thickest slice is not yet cooked through. The portion planning can in particular depend on whether the portions are each to have a predefined weight or whether the weight can vary—within predefined tolerances—, for example, if the portions are priced by weight when sold to the end consumer.

Up to now, the portion planning has taken place such that a cutting plan is created for each individual product from the product data obtained, which cutting plan considers three different product regions, namely the product start, the product end and between them the usable product section that can be sliced into usable slices and can thus be used to form portions. The product start, also designated as the first cut or trim cut, is that region of the product which has to be cut away at the beginning if the cut-off slices are too light or too small, for example. The product end is that region at the end of each product which likewise cannot be sliced due to its shape or due to the intervention of a product holder. Those parts of the product which are obtained when slicing the product start and, if applicable, also the product end are also referred to here as unusable product parts—in contrast to the usable slices.

In the prior art, three operating modes of the slicing apparatus are therefore required for the cutting plan of each product, said operating modes each having their own settable parameters, namely a separate operating mode for the product start, for the usable product region and for the product end in each case. Special software must be loaded into a processor of the slicer control for each operating mode. The constant switching between these operating modes, i.e. the repeated reloading of the corresponding computer programs, in practice typically requires a time effort of several seconds in each case and is thus detrimental to the product throughput, in particular in the case of relatively short products. This is quite a relevant figure when considering that in the food processing industry there are often a plurality of production lines in a production facility that each have a high-speed slicer that is in practically continuous use in a multi-shift operation.

The object of the invention is therefore to increase the product throughput when slicing food products without compromising the slice quality and portion quality.

This object is satisfied by the features of the independent claim 1 and in particular in that the change in the feed speed of the product conveying device is controlled by means of a computer program that, during the slicing of each product, is executed without a program change for the entire product, including the product start and the product end, in a processor of the control device.

The invention thus leaves the well-trodden path of a software-based differentiation between usable and unusable product regions already in the program-controlled feeding of the products. Instead, for each product, the product start and the product end (and any product sections disposed therebetween), whose slicing can result in unusable product parts, up to and including the creation of the real slices taking place by means of the cutting blade, are treated in the same way in terms of software as product regions resulting in usable slices. Therefore, a “reloading” of computer software solely for the slicing of the product start and the product end—or generally of unusable product regions—and thus a switching back and forth between differently program-controlled operating modes are hereby avoided.

Advantageous embodiments of the invention are also set forth in the dependent claims, in the description and in the drawings.

The contour and/or structure detection, viewed in the conveying direction, can take place at a spacing from the cutting plane, which spacing is smaller than the product length but greater than the portion thickness, in particular greater than a maximum portion thickness known for a respective application. This means that at the start of the slicing of a respective product, it is indeed not yet known for the entire product, but at least for the first portion, how the feed speed of the product conveying device must be controlled in order to form the portion in accordance with the portion planning. Alternatively or additionally, the contour and/or structure detection, viewed in the conveying direction, can take place at a spacing from the cutting plane, which spacing is greater than the product length. In this case, a respective product is then so-to-say completely “planned through” before the slicing is started at this product.

In principle, it is possible that the contour and/or structure detection takes place at a plurality of positions spaced apart in the conveying direction. For example, a structure detection can take place in front of the slicing apparatus and a contour detection can take place within the slicing apparatus. It is also possible to provide two positions for the contour detection that are spaced apart in the conveying direction, for example, a scanning position in front of the slicing apparatus and a scanning position integrated into the slicing apparatus. Other constellations are likewise possible.

According to further embodiment examples, it can be provided that the transitions between two directly consecutive products, said transitions each comprising a product end and a product start, are considered during the portion planning, wherein it is permitted that a respective portion comprises slices from two directly consecutive products.

Therefore, during the portion planning, no attempt is made to obtain complete portions from only one single product in each case. Rather, the entire sequence of directly adjoining products is so-to-say “planned through”, without considering actually present product transitions, so that the completed real portions can also comprise slices from two directly consecutive products, wherein possibly present unusable product parts are first recognized and can then be ejected after the slicing, i.e. if they are actually present.

According to some embodiment examples of the invention, it can be provided that, during the portion planning, a distinction is made between usable slices and unusable product parts on the basis of the predefined portion data and unusable product parts are excluded from the portion formation.

As already mentioned elsewhere, the unusable product parts recognized as such during the portion planning can, for example, be ejected after the cutting off so that they are excluded from the formation of the desired target portions.

It can be provided that the product feed is stopped to interrupt the cutting off of slices, in particular to eject unusable product parts.

Furthermore, it can be provided that, immediately before a stopping of the product feed and/or immediately after a restarting of the product feed, said restarting taking place subsequent to a stopping, a compensating product push already takes place, in particular by a distance that is smaller than a slice thickness provided in accordance with the portion planning.

This is in particular advantageous if, according to possible further developments, the cutting blade is not moved away from the cutting plane during the interruption of the product feed, i.e. the cutting blade does not perform any blank cuts in the usual sense by a so-called disengagement of the cutting blade or of the slicer cutting head comprising the cutting blade (the concept of blank cuts when slicing food products is generally known to the skilled person so that there is no need to go into more detail here). Without the additional compensating product push provided according to this further development of the invention, it could namely happen that, due to the relaxing front product end and the cutting blade that unavoidably continues to move in so doing, a so-called shred formation takes place immediately after a stopping and/or a restarting of the product feed and/or a wedge-shaped slice is cut off. The additional compensating product push, on the other hand, results in a complete slice having the predefined weight. Otherwise a slanted cutting surface would result at the front product end, i.e. the next slice could not be cut off in a straight manner.

Furthermore, it can be provided that a portioning support, which is arranged downstream of the cutting blade and onto which the cut-off slices fall, can be adjusted between at least one portioning position and at least one ejection position in order to eject unusable product parts. This adjustment can comprise a pivot movement, a linear movement, preferably in a vertical direction, or a combination of a pivot movement and a linear movement. Preferably, the portioning support is simply folded down to the front, in particular by a pivoting, such that the front end, viewed in the transporting-away direction, is pivoted downwardly. One advantage here is that the portioning support does not need to be operated in the reverse direction, for example, an endless belt conveyor forming the portioning unit does not need to be operated “in reverse”. Rather, it is hereby made possible that the unusable product parts cannot be discharged to the front simply by driving, for example, an endless belt conveyor forming the portioning unit.

In principle, the adjustment of the portioning support for ejecting unusable product parts can, for example, be a pure folding down, a pure vertical movement or a combination of both.

According to some embodiment examples of the invention, a portioning support, which is arranged downstream of the cutting blade and onto which the cut-off slices fall, can be adjusted in order to carry out a portion completion in that a first part portion is first formed on the portioning support and is then transferred to a following unit arranged downstream, in particular a so-called control belt, thereupon unusable product parts falling onto the portioning support are ejected, subsequently a second part portion is formed on the portioning support and is then placed onto the first part portion by means of the portioning support, in particular by executing an adjustment movement of the portioning support comprising a pivot movement, in order thus to form a completed total portion from the two part portions.

Such a portion completion can in particular be carried out particularly well if so-called shingled portions are formed, as is usually the case when slicing bacon products, for example.

Such a portion completion can be carried out in a particularly advantageous manner with a portioning support that—as already mentioned above—can be folded down to the front, i.e. lowered with its front end, viewed in the transporting—away direction, for example by a pure pivot movement. It is then namely not necessary to convey the first part portion back onto the portioning support. Rather, due to this embodiment according to the invention, the first part portion can wait on the following unit arranged downstream in the region of the transition between the portioning unit and the following unit. As soon as the second part portion is formed on the portioning support, the latter can be adjusted into a position such that the second part portion can be placed onto the first part portion. A slanted position of the portioning support that is suitable for this purpose can, for example, be achieved in that the portioning support is moved vertically upwardly and its front end is lowered. Alternatively, the portioning support can conversely be moved vertically downwardly and its front end can be moved upwardly. The lowering and raising of the front end can in particular take place by pivoting, and indeed before, after or during the vertical movement. Further alternatively, either the rear end or the front end of the portioning support can be raised without a vertical movement in order to achieve the slanted position. A combined adjustment movement can also be provided, in particular to achieve that the front end of the portioning support is optimally positioned relative to the following support and the first part portion disposed thereon.

Preferably, the portioning unit and the following unit are endless belt conveyors, i.e. the portioning support and the support of the following unit are each formed by the upper side of an endless belt that can be a wide conveyor belt or a plurality of individual conveyor belts spaced apart in the transverse direction. In the present technical field, the portioning unit is also referred to as the portioning belt and the following unit arranged downstream as the control belt.

In some embodiment examples, it can be provided that the portioning support is adjusted by means of a servo drive. It is hereby in particular possible to adapt the course of the adjustment movement to a respective current transporting-away situation or portion completion.

Compared to known pneumatic adjustment devices for the portioning support, a servomotor drive has advantages since the adjustment paths can be controlled more precisely by means of a servomotor and limited to the respective required measure. This provides an additional time saving. The adjustment of the portioning support can also be flexibly adapted in dependence on the respective situation. If, for example, only a few or relatively small unusable product parts are to be ejected, the portioning support, for example, only needs to be slightly folded down and/or moved for this purpose since the gap required for the ejection between the portioning support on which the product parts lie and the underside of the following unit can be small. A vertical travel that is, for example, required for a portion completion can also already begin while unusable product parts are cut off and fall onto the portioning support.

According to some embodiment examples, it can be provided that the portion planning takes place such that the slices of a respective portion all have at least approximately the same slice thickness. This is often desirable in practice, in particular when slicing bacon products.

Furthermore, it can be provided that the portion planning takes place such that the k (k≥1) last or first portions of a respective product each have a portion weight that is reduced or increased compared to the other portions. The reduction or increase can in particular be predefinable by parameters. In particular, it can further be provided that, for a respective product, the reduction or increase increases or decreases continuously within the k portions.

In particular when the product feed works without product holders engaging at the rear product end, due to the acting cutting forces of the cutting blade at the product end and possibly also at the product start, a lateral warping or a deformation in the direction of a lateral product abutment can occur. A resulting tendency towards a higher slice weight is observed in practice. The embodiment example of the invention mentioned here can compensate for this in that, for example, for the last two, three or four portions in the portion planning, a respective set desired portion weight accordingly decreases steadily towards the product end in order thus to already compensate for the effect of the increasing slice weights by means of a corresponding specification in the portion planning.

Another effect is observed in practice when product holders engaging at the rear product end are provided and press the front product end against an abutment during a gripping process in each case, whereby the product is in particular compressed at its front end. If the product abutment is removed immediately before the slicing, the front product end can relax again. The impacts of this effect can also be compensated for by an appropriate portion planning.

In the slicing apparatus according to the invention, it can be provided that the apparatus has an integrated scanning device for detecting the contour and/or structure of the products. Alternatively or additionally, it can be provided that the control device of the slicing apparatus is configured to receive information relating to the contour and/or structure of the products from an external scanning device and to process said information. Such an external scanning device can, for example, be a separate contour or X-ray scanner that is arranged upstream of the slicing apparatus and represents an independent machine.

It can be provided that the scanning device for detecting the contour of the products operates in accordance with the light sectioning method. Alternatively or additionally, it can be provided that the scanning device, which in particular operates in accordance with the light sectioning method, comprises a plurality of individual scanners arranged around the product support—i.e. around a respective product during the operation. The individual scanners can in particular each be arranged within the slicing apparatus. The individual scanners can, for example, be so-called compact sensors, such as are described in DE 10 2016 102 034 A1 and DE 10 2016 101 753 A1.

Furthermore, it can be provided that the product conveying device has one or more conveying devices, in particular exclusively, laterally engaging at the products, in particular endless belts, rolls and/or rollers. It is hereby not necessary to push the products from behind. However, this can, alternatively, be provided, for example, by means of relatively thin sliders positioned in a perpendicular manner, i.e. plate-shaped sliders, that are, for example, attached to a circulating belt or a chain below, above or to the side of the products and that are each inserted between two consecutive products.

Furthermore, it can be provided that the apparatus comprises a portioning unit, in particular a portioning belt that has a portioning support onto which the slices cut off by means of the cutting blade fall, and a following unit, in particular a control belt, that is arranged downstream of the portioning unit and that has a following support to which the portioning unit transfers the slices, wherein the portioning unit is adjustable, in particular pivotable, during the operation such that the portioning support can be adjusted between at least two positions that differ from one another with respect to the orientation of the portioning support relative to the following support of the following unit.

With regard to possible adjustment processes for the portioning support and the applications associated therewith, in particular for ejecting unusable product parts or for the portion completion, reference is made to the above statements on the method according to the invention.

Both the portioning unit and the following unit can each be an endless belt conveyor, as already mentioned above. In the following, the portioning unit is also simply referred to as the portioning belt and the following unit is also simply referred to as the control belt.

The control belt in particular serves to transport away the fully formed portions in a transporting-away direction that is directed away from the portioning belt. If portions are formed from areal slices, for example stacked or shingled slices, the portions are then usually formed on the portioning belt and transferred to the control belt. Alternatively, the portioning belt can transfer the slices individually after one another to the control belt on which the formation of a respective portion takes place. This is in particular the case with so-called generally known “shaved” or “shaved food” applications in which, for example, “shaved meat” portions are formed from sausage slices or “shaved cheese” portions are formed from cheese slices.

The “shaved food” portions are produced by compressing the individual slices that are transferred one after another, in particular individually, from the portioning belt to the control belt. The compression takes place by a speed difference in that, for example, the control belt moving in the transporting-away direction is slower than the portioning belt. The friction between the slices and the support of the control belt ensures the desired slice compression and has the result that the slices rise or bulge. A plurality of such compressed slices then results in a “shaved food” portion with a typical portion pattern whose specific appearance depends on a plurality of parameters, in particular the stiffness, the thickness and the size of the individual slices, i.e. so-to-say on the mechanical properties of the product slices, but also on the speeds of the two belts and the speed difference.

When forming “shaved food” portions, the problem regularly occurs in practice that the first slice lies substantially flat under the portion and the portion falls apart during the transport away due to the acceleration, in particular in the region of the last slices. The portion pattern is hereby destroyed or at least severely impaired. Furthermore, the length of the portion is hereby increased, which has to be corrected afterwards with a considerable effort using special measures. For example, the portions each have to be “pushed back together” again to the correct size with the help of robot grippers or by different belt speeds. Otherwise, larger packaging would have to be selected, which would entail economic disadvantages.

Consequently, an object of the invention is to be able to create “shaved food” portions with as stable a portion pattern as possible.

This object is satisfied in each case by the features of the independent apparatus claim 17 and of the independent method claims 21 and 22.

According to a variant of the apparatus according to the invention, it is provided that the portioning unit is adjustable, in particular pivotable, during the operation such that the portioning support can be adjusted between at least two positions that differ from one another with respect to the orientation of the portioning support relative to the following support of the following unit. Due to such an adjustability, the impact of the cut-off product slices on the following support can in particular be optimized in dependence on the desired properties of the portions and on the mechanical properties of the product slices so that “shaved food” portions with a stable portion pattern can be produced overall.

According to another variant of the apparatus according to the invention, which can be combined with the above-mentioned variant, it is provided that a portion formation from slices transferred one after another, in particular individually, by the portioning unit takes place on the following support, wherein the portioning unit has a transfer section that merges into a transfer end disposed above the following support and that forms a support surface for the slices in front of the transfer end, said support surface sloping down towards the following support.

The transfer section of the portioning unit can be adjustable in order to change the orientation of the support surface in space.

Regardless of whether the transfer section is adjustable or not, a sloping “ramp” for the slices is so-to-say formed by the support surface of said transfer section. The slices do not leave the support surface in a horizontal direction, nor do the slices simply fall vertically downwardly from the portioning unit onto the following support located below the portioning unit. Rather, the slices can here so-to-say be dropped obliquely downwardly onto the following support, i.e., in physical terms, the transfer does not take place by a horizontal throw or a free fall, but by a slanted downward throw. Due to the movement of the portioning support, in particular by a circulating conveyor belt of the portioning unit, the product slices leave the support surface of the transfer section at a speed other than zero. Depending on the actual conditions, in particular on the relative arrangement of the transfer section and the following unit and on the dynamic conditions such as the speed at which the product slices leave the support surface of the transfer section, the transfer of the slices can also take place by a pushing onto the following support if there is no question of a throwing of the slices.

Preferably, there is no more or less direct transition between the transfer end of the transfer section and the following support, but the following support is rather arranged at a vertical spacing below the transfer end.

According to a preferred further development of the invention, it is provided that the following support extends opposite to the transporting-away direction beyond the transfer end of the portioning unit below the portioning unit, wherein the following support can at least temporarily be moved opposite to the transporting-away direction during the portion formation, wherein a clear height at least for a part of a respective portion is present between the portioning unit and the section of the following support that extends below the portioning unit.

If the transfer of the slices to the following support and the transporting away of the formed “shaved food” portion is designated as a forward movement at least with respect to one movement component, the following support is therefore at least temporarily moved backwards during the portion formation, wherein the following support extends to the rear beyond the transfer end of the transfer section. The portioning unit and the following support are thus arranged in an overlapping manner.

It has been found that such an opposite movement of the portioning unit transferring the slices, on the one hand, and of the following support receiving the slices, on the other hand, results in a stable portion pattern so that the portions do not fall apart either during the acceleration for the transporting away or in subsequent handling processes. Overall, this results in significantly more compact and more stable “shaved food” portions.

The backward movement of the following support preferably already takes place when transferring the first slice of a respective portion. In particular, the following support moves backwards during the entire formation of a respective portion, wherein the speed can be constant or can vary during the portion formation. The speed during the backward movement is in particular lower than when transporting away a respective completely formed portion in the forward direction, i.e. in the transporting-away direction.

It can be provided that the clear height between the portioning unit and the section of the following support extending below the portioning unit can be adjusted in dependence on the properties of the slices and on the other production conditions with a view to an optimization of the portion pattern. It is understood that the clear height is in any case so large that at least the part of the portion that is formed first and that has a certain height due to the compressed and hereby raised or bulged slices can be moved under the portioning unit during the portion formation.

The transfer section, including the transfer end, can be shaped like a nose overall, wherein the transfer end forms the tip of the nose and the support surface forms the bridge of the nose.

The support surface of the transfer section is not formed by a relatively “sharp” rounding as in a comparatively small deflection roller of a conventional endless conveyor belt of a portioning belt, but the support surface rather represents a surface on which the slices are areally disposed, i.e. the transfer section provides a support surface at least for a part of a respective slice. The sloping support surface can therefore be smaller than a respective slice. The support surface can comprise at least one planar or convexly curved section.

The actual portioning support of the portioning unit onto which the slices fall after the cutting off can extend horizontally. The support surface of the transfer section can form at least one part of the transition from the portioning support into the transfer end. Alternatively, the portioning support itself can form the support surface. In particular, a single planar or convexly curved portioning support can be provided that slopes down towards the following support and thus forms the support surface. It can be provided that the course of the support surface of the transfer section can be adjusted relative to the following support of the following unit during the operation and/or for adaptation to a respective application.

In addition, it can be provided that the slicing apparatus furthermore comprises a control device that is configured to perform the slicing of the products in accordance with a method disclosed herein, in particular as described above.

In a method according to the invention for forming “shaved food” portions in accordance with claim 21, it is in particular provided that the slices successively reach a first support and, by moving the first support, are transferred to a moving second support disposed below the first support, wherein the first support and the second support overlap one another and move in opposite directions, in particular wherein the slices are moved obliquely downwardly towards the second support during the transfer. The movement of the two supports in opposite directions has the result that a respective slice moved by means of the first support has, on the impact on the second support, a movement component that is directed opposite to the direction of movement of the second support.

In a further method according to the invention in accordance with claim 22, it is in particular provided that the following support extends opposite to the transporting-away direction beyond a transfer end of the portioning unit below the portioning unit and a clear height at least for a part of a respective portion is present between the portioning unit and the section of the following support that extends below the portioning unit, wherein the portions are each formed in that the following support is moved opposite to the transporting-away direction while the slices are transferred from the portioning unit to the following support.

In this respect, it can in particular be provided that the slices are moved obliquely downwardly towards the following support during the transfer by means of the portioning unit, in particular wherein the portioning unit has a transfer section that merges into a transfer end disposed above the following support and that forms a support surface for the slices in front of the transfer end, said support surface sloping down towards the following support.

### BRIEF DESCRIPTION OF THE DRAWINGS

The invention will be described in the following by way of example with reference to the drawings. There are shown:

FIG. 1 schematically, in a side view, a slicing apparatus with devices arranged downstream according to an embodiment example of the invention and, in FIGS. 1a, 1b, 1c and 1d, additional representations for further explanation; and

FIGS. 2a and 2b an embodiment example of a portioning unit according to the invention that can be used in a conventional slicing apparatus or in a slicing apparatus according to the invention.

### DETAILED DESCRIPTION

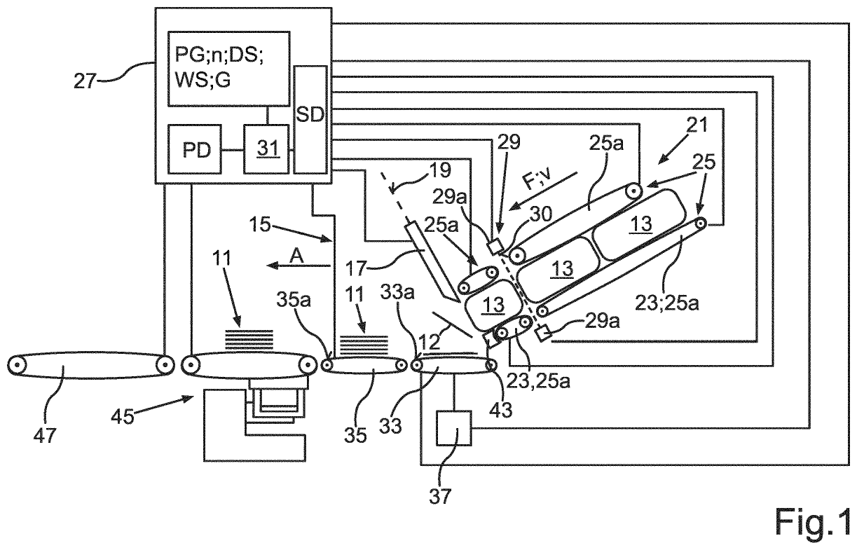

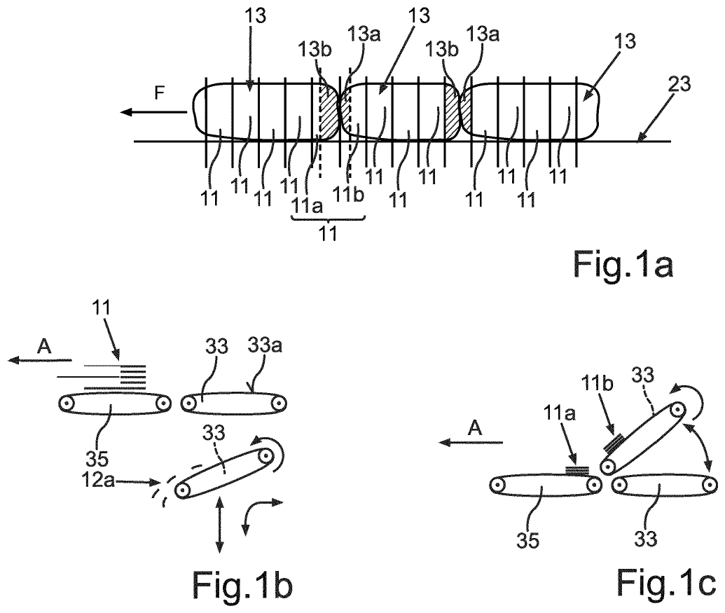

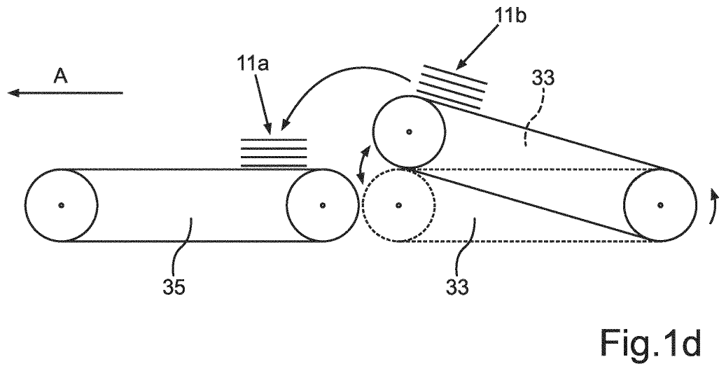

The slicing apparatus 15 schematically shown in FIG. 1 is a high-speed slicer whose cutting blade 17 is, for example, configured as a scythe-like blade whose cutting edge defines a cutting plane 19 and interacts with a cutting edge 43, which forms the front end of a product support 23 for the products 13, to cut off slices 12 from food products 13 fed in a conveying direction F.

During the operation, the blade 17 rotates about an axis, which is not shown and which extends perpendicular to the cutting plane 19, at a cutting speed that is between several hundred and some thousand revolutions per minute. Each revolution of the blade 17 is a cutting movement with which a slice 12 can be cut off from a respective front product end.

In the example shown, the product support 23 is not only a support for the products 13, but simultaneously a component of a product conveying device 25 that serves to feed the products 13 to the cutting plane 19 at a variable feed speed v in the conveying direction F. The product conveying device 25 further comprises two upper conveying devices 25a, for example, in the form of traction belts that engage at the upper product sides. Alternatively or additionally, it is possible to use driven transport rolls or transport rollers whose surface structure can be suitably selected. The surface structure can have teeth or points that at least partly engage into the respective product, wherein an engagement into the product is not absolutely necessary to effect a transport.

In this example, both the upper conveyors and the lower conveyors each comprise a short conveyor 25a disposed closer to the cutting plane 19 and a conveyor 25a of a greater length at the rear in the conveying direction F. Both at the upper side and at the underside of the products 13, the conveyors 25a are slightly spaced apart in the conveying direction F, whereby a gap is produced that is used by a scanning device 29 that will be looked at in more detail in the following.

The product conveying device 25 comprising the conveyors 25a forms a product feed 21 that can comprise further components and that can generally also be configured differently. For example, in another embodiment, the product support 23 can be formed by fixed support surfaces on which the products 13 slide during the feed. Alternatively or additionally, it is also possible to provide conveyors that laterally engage at the products 13.

In the example shown, the products 13 are fed in a sequence of directly adjoining products 13, wherein a respective product end 13b and a product start 13a contact one another (cf. FIG. 1a). In practice, in particular bacon products can be sliced in this way. Since no loading pauses are required, the slicing of the products 13 therefore takes place continuously here, i.e. an endless sequence of products 13 can be spoken of that are practically sliced in an uninterrupted permanent operation of the slicer 15 by the latter.

The loading of the product feed 21 with the products 13 can take place by a magazine, not shown, that automatically lifts and places the products 13 so that the product support 23 does not have to be lowered for the loading.

The slicing apparatus 15 can operate with one track or multiple tracks. In a multi-track operation, a plurality of products 13 disposed next to one another transversely to the conveying direction F are simultaneously sliced. The cutting blade 17 is then active quasi simultaneously in a plurality of tracks, i.e., per cutting movement of the blade 17, in each track, a slice 12 can be cut off from the product 13 located in said track. In this respect, the product feed 21 can work individually per track, which means that the feed speed v can be regulated in each track independently of the other tracks. Thus, it can be achieved that-although the cutting blade 17 is simultaneously active in all the tracks slices 12 of different thicknesses can be cut off from the front product ends disposed next to one another: The greater the feed speed v, the further the respective product 13 is advanced beyond the cutting plane 19 and the thicker the slice 12 is that is cut off from the front product end during the subsequent cutting movement of the cutting blade 17.

In the example shown, a detection of the inner structure of the products 13 does not take place. For this purpose, an X-ray scanner arranged upstream of the slicer 15 could additionally be provided, for example. In the present case, only a contour detection, i.e. a detection of the outer shape of the products 13, takes place by means of the aforementioned scanning device 29 that has a plurality of individual scanners 29a that are arranged around the product support 23, i.e. around the path provided for the products 13 during the feed, and that are each small in comparison with the size of the slicer 15 and also with the size of the products 13. Such compact sensors are generally known so that they will not be looked at in more detail here.

Each individual scanner 29a operates, for example, in accordance with the light sectioning method and provides information about the product contour over a respective peripheral angle range. Due to the aforementioned spacing between the conveyors 25a, the scanning can take place over the full periphery, i.e. over 360°, around the products 13 in the scanning plane 30. As mentioned elsewhere, however, a 360° scanning is not absolutely necessary. It can therefore be sufficient if the plurality of individual scanners 29a are arranged around the products 13 such that only a partial peripheral region of less than 360° is scanned. The scanning plane 30 is shown purely by way of example as extending perpendicular to the conveying direction F. However, this is not absolutely necessary. The scanning planes of the individual scanners 29a can diverge, i.e. the lines that are produced on the product surface by means of the individual scanners 29a do not all have to lie in the same plane. In principle, the contour detection by means of scanners that operate in accordance with the light sectioning method is known so that it is not necessary to look at it in any more detail here.

The cut-off slices 12 fall onto a portioning unit 33 that is configured here as an endless conveyor belt and is also referred to below as a portioning belt. The conveyor belt forms a portioning support 33a onto which the slices 12 fall. The formation of a portion 11 from slices 12 disposed above one another takes place on the portion belt 33 that transfers finished portions 11 to an adjoining following unit 35 that is likewise configured as an endless conveyor belt and that is also referred to below as the control belt. The endless conveyor belt of the control belt 35 forms a following support 35a for the portions 11.

No “shaved” application is shown here, but the cut-off slices 12 rather retain their areal configuration during the portion formation and -as shown here-are placed on top of one another to form stacks of slices that form one portion 11 in each case. Alternatively, shingled portions 11 can be formed, as is in particular typical for the slicing of bacon products. In this respect, the portioning belt 33 moves comparatively slowly in a transporting-away direction A during the slicing so that consecutive slices 12 do not lie exactly above one another, but are slightly offset from one another so that a shingled portion is produced overall that is likewise transferred to the control belt 35 after completion.

The portion transfer from the portioning belt 33 to the control belt 35 takes place at a comparatively high transporting-away speed so that the cutting off of slices 12 only has to be interrupted for a short time and the portioning belt 33 is ready again as quickly as possible to pick up slices 12 for the formation of the next portion 11.

If no slices 12 are to be cut off temporarily, the product feed 21 is temporarily stopped. The cutting blade 17 continues to rotate, but then does not cut off any slices 12 from the respective front product end. In many known slicers, at least a part of the blade head, which is not shown and which comprises the cutting blade 17, is moved parallel to the axis of rotation of the blade 17 and thus slightly away from the front product end in the conveying direction F, i.e. is disengaged by a short distance of e.g. a few millimeters, so that no so-called shredding formation occurs, i.e. so that no unwanted product parts are cut off from a front product end that is relaxing and thus projects at least partly beyond the cutting plane 19 despite the product feed 21 being stopped. However, it is also possible to work without such a disengaging of the cutting blade 17 and to accept the cutting off of unwanted product parts. This is likewise referred to as the carrying out of blank cuts here. Such product parts can be ejected just like other unusable product parts, which will be discussed in more detail elsewhere. In particular in the case of the continuous slicing of an endless sequence of bacon products that is shown here, the carrying out of blank cuts without disengaging movements is preferred since this saves time and thus increases the product throughput, and indeed despite the possibly resulting necessity of the ejection of product parts cut off in an unwanted manner.

In the embodiment example shown, the finished portions 11 are transferred to a scale 45 arranged that is arranged downstream of the control belt 35 and that likewise comprises an endless conveyor belt. The portion weight is determined by means of the scale 45. The scale 45 is adjoined by a further conveyor 47 that here represents the following transport devices. While the portioning belt 33 and the control belt 35 belong to the slicer 15, the further components-such as the scale 45 and the conveyor 47—are components of a transport path that adjoins the slicer 15 and that in practice usually leads to a packaging machine, not shown here, at which the portions 11 are automatically packaged. At the end of the packaging machine, i.e. at the end of the entire processing line comprising the slicer 15, the transport path and the packaging machine, in many applications there is also a so-called “end-of-line” scale by which the portion weight can be checked.

The operation of the slicer 15, and thus also the portion formation, is controlled by a schematically indicated control device 27 that inter alia comprises a processor 31. The processor 31 can be part of a larger processor unit or can form the processor unit of the control device 27. In addition to the slicer 15, the control device 27 can also control the devices arranged downstream of the slicer 15 and, if necessary, also the entire processing line including the slicer 15, the transport path and the packaging machine.

The control device 27 determines the cross-sectional area of the respective product 13 from the product contour, which is detected by means of the individual scanners 29a, at each position of the respective product 13 in the conveying direction F at which a scanning has taken place and—since the scanning ultimately takes place at discrete positions—determines the product volume or a measure of the product volume by interpolation between the cross-sectional areas determined by scanning. Thus, for each product section between two cross-sectional areas that have a spacing from one another in the conveying direction F, the volume of the respective product section can be calculated from these product data. If, in addition, the density of the product 13 is determined by a prior weighing or in another way, as explained in the introductory part, the weight of each product section can thus be calculated from the volume, i.e. the weight of each product section having a certain thickness, i.e. of each product slice 12.

Since the position of the scanning device 29 and thus also the spacing of each cross-sectional area determined by the contour detection from the cutting plane 19 as well as the feed speed v at each point in time are known, for each cut-off product section—and thus also for each slice 12—the weight thereof or at least a measure of its weight are thus known to the control device 27.

On this basis, by means of the control device 27, a portion planning can consequently take place, for which the respective desired parameters of the portions 11 to be formed can be considered. This can in particular be the portion weight PG, the number of slices n, the slice thickness DS, the slice weight WS and the slice size G. Not all of these parameters have to be fixedly predefined in each case. For example, a variable number n of slices can be allowed in the individual portions 11, wherein the slice thickness DS and portion weight PG—within respective tolerances or ranges—are fixedly predefined. Depending on the course of the outer shape of a respective product 13 in the feed direction F, a larger or a smaller number n of slices 12 can then be required to form the portion 11 in the desired manner in order to achieve a specific portion weight while maintaining the desired slice thickness DS.

The portion planning is implemented by calculating control data SD for the product feed 21 on the basis of the portion planning. On the basis of these control data SD, the product feed 21 is controlled in that the thickness DS of each individual cut-off slice 12 can be achieved in accordance with the portion planning by changing the feed speed v of the product conveying device 25.

Such a portion planning, including the corresponding portion formation, is generally known and proven in practice. Naturally shaped products are actually not exactly cuboid despite possible previous measures—such as the pressing into an approximately cuboid shape. In practice, the entire product thus cannot be cut into usable slices. As also already mentioned in the introductory part, slices that are too small for a portion formation, i.e. that have a cross-sectional area that is too small, can be produced when slicing the product start and the product end. Density inhomogeneities such as hollow spaces in cheese can also lead to unusable slices if they are indeed sufficiently large but, for example, too light for a respective application due to the holes created by the hollow spaces during the slicing.

All of this can be taken into account in the portion planning based on the recorded product data and by considering the predefined portion data. Due to the portion planning, it can thus be predefined or each section of a product 13, i.e. so-to-say for each imaginary slice of the product 13 that has not yet been sliced, whether this product section is a usable product slice 12 or should be sliced into a usable product slice 12, or whether this product section is to be ejected as an unusable product part 12a.

In this respect, this not only takes place for a respective one product 13 independently of the other products 13, but rather for the entire product sequence. In other words, for the portion planning, the entire product sequence is so-to-say regarded as a single uninterrupted product that passes the scanning device 29 during the product feed and that is divided into portions 11 of usable slices 12, on the one hand, and product parts 12a to be ejected, on the other hand, during the portion planning. This is illustrated in FIG. 1a in which three directly consecutive products 13, which are disposed on a product support 23, are shown purely by way of example.

The vertical lines in FIG. 1a each represent the start or end of a portion 11 as a result of the portion planning. In the region of a respective transition between two directly consecutive products 13, it is illustrated how the portion planning distinguishes between usable product sections and unusable product parts. The unusable product parts are shown hatched here and correspond to an unusable product start 13a or an unusable product end 13b in this example.

Consequently, there is a respective portion 11 between two directly consecutive solid lines, wherein this also applies to the product transition at the left in FIG. 1a, wherein, however, due to the unusable product sections (product start 13a and product end 13b), the portion 11 there comprises a first part portion 11a of the one product 13 and a second part portion 11b of the immediately following product 13. After the slicing, the real portion 11 is formed from these two part portions 11a, 11b by a portion completion by means of the portioning belt 33 and the control belt 35, which will be discussed in more detail below in connection with FIG. 1c.

In other words, a respective portion 11 or part portion 11a, 11b can be “artificially extended”, so to speak, during the portion planning, namely by an unusable product section. This unusable product section can comprise at least a part of the unusable product end 13b or product start 13a and possibly also both the entire product end 13b and at least a part of the immediately following product start 13a, or vice versa, but is no longer present in the actual portion 11 after the slicing.

With the other product transition in FIG. 1a, the right-hand product transition, it is shown purely by way of example that a complete portion 11 ends just at the product end 13b of the one product 13 and thus the next complete portion 11 begins after the portion start 13a of the next product 13 so that no portion completion from part portions is required for this product transition.

The vertical lines are only shown equidistant here for the sake of simplicity. This will not usually be the case in practice, and indeed due to the product cross-sectional area of the individual products 13 that varies in conveying direction F and also due to density fluctuations, unless a constant average product density is assumed for the portion planning.

As already mentioned elsewhere, the portion planning not only comprises the definition of the start and end of the portions 11 illustrated in FIG. 1a, but also further parameters, for example the number n of the slices of a respective portion 11 and the slice thickness DS, which is often constant, in particular when slicing bacon products, wherein the slice weight WS and the slice size G or the minimum and/or maximum values in this respect can furthermore be defined.

On the basis of the portion planning, the control device 27 calculates the control data SD for the product feed 21. On the basis of these control data SD, the product feed 21 is then controlled by the control device 27 such that, by changing the feed speed v of the product conveying device 25, the thickness DS of the cut-off slices 12 results according to the portion planning.

If—as in the embodiment example of FIG. 1—the scanning device 29 is located at a spacing from the cutting plane 19, which spacing is smaller than the length of the products 13, it is then known at any point in time during the slicing, in each case for the product section between the scanning plane 30 and the cutting plane 19, how the product feed 21 must be controlled, i.e. how the feed speed v must be varied, in order to slice this product section in accordance with the portion planning. The portion planning, the calculation of the control data SD and the control of the product feed 21 therefore take place continuously during the feeding of the products 13 and the scanning of the products 13 by means of the scanning device 29 taking place in so doing.

The control of the product feed 21 on the basis of the control data SD, i.e. the changing of the feed speed v for the products 13 fed to the cutting plane 19, takes place by means of a computer program that is executed continuously in the processor 31 of the control device 27 during the slicing of the sequence of products 13. The execution of this program is not interrupted during the slicing, i.e. this program runs even if product sections that are unusable according to the portion planning, in particular product starts 13a and product ends 13b, are sliced. In other words, a distinction is not made in terms of the software between usable product sections, on the one hand, and unusable product sections, such as in particular product starts and product ends, on the other hand. During the slicing of each product 13, the program is therefore executed without a program change for the entire product 13, including the product start 13a and the product end 13b, in the processor 31 of the control device 27. The previously typical reloading of special computer programs, which control the product feed 21 and possibly further components of the slicer 15 for the slicing of the unusable product sections, i.e. in particular the product starts 13a and the product ends 13b, is avoided by the procedure according to the invention. As a result, a considerable time saving of up to several seconds per product 13 can be achieved compared to the conventional practice.

In addition to the control of the product feed 21, the computer program executed by the processor 31 can possibly also control further processes at the slicer 15, for example, a blank cut management either with disengagement or—in the present case when slicing an endless sequence of bacon products—without disengagement, if necessary, with a respective compensating product push before stopping and/or after restarting the product feed 21, as already explained above.

Furthermore, the computer program can perform the control of the portioning belt 33 and the control belt 35, i.e. the actual portion formation including the ejection of unusable product parts 12a and, if necessary, a portion completion, as already described elsewhere.

The slicer 15 is furthermore characterized in that the portioning unit 33 can be adjusted. The adjustment of the portioning belt 33 does not mean the conveying movement of the endless belt, which forms the product support 33, for transferring portions 11 or part portions 11a, 11b to the subsequent control belt 35, but rather an adjustment movement such that the position and/or the orientation of the portioning support 33a changes/change in space and thus in particular relative to the following support 35a of the control belt 35.

In this embodiment example, the adjustment of the portioning belt 33 takes place by means of a servo drive 37. Servo drives have the advantage that the position of the respective servomotor and thus that of the object to be moved by means of the servomotor are known at all times. Servo drives thus enable very precise and in particular flexible adjustment movements adapted to the respective situation.

The adjustment of the portioning belt 33 for ejecting unusable product parts 12a, such as are in particular produced when slicing a product start 13a or a product end 13b, is illustrated in FIG. 1b. As indicated by the two double arrows, starting from an upper portioning position with a horizontal portioning support 33a, the portioning belt 33 can be moved vertically and pivoted about an axis such that the portioning belt 33 is folded down to the front. In the lower folded-down position (ejection position), the unusable product parts 12a can be transported away by moving the endless belt in the direction indicated by the arrow and can, for example, fall into a container that is not shown. The servo drive 37 (FIG. 1) makes it possible that, in dependence on the respective conditions, the portioning belt 33 is folded down vertically and to the front only as far as is necessary to transport the product parts 12a through the intermediate space between the control belt 35 and the portioning belt 33, which is shown in exaggerated size here. The respectively required manner of adjusting the portioning belt 33 can be determined by the quantity and/or size of the unusable product parts 12a known from the portion planning. Furthermore, it can be achieved by the servo drive 37 that the control belt 33 is already moved vertically downwardly when the unusable product section is still being sliced.

An advantageous manner of a portion completion by means of the adjustable portioning belt 33 is shown in FIG. 1c. In this respect, the portioning belt 33 can be adjusted such that it can be pivoted into a slightly raised and inclined position, as indicated by the double arrow. As soon as a first part portion 11a has been formed and transferred to the control belt 35 (cf. also the left-hand product transition in FIG. 1a), a transporting away of unusable product parts 12a—as explained above with reference to FIG. 1b—can take place, whereupon a second part portion 11b is formed on the portioning belt 33, which is still in the portioning position, and said portioning belt 33 is then inclined in accordance with FIG. 1c, and indeed such that the second part portion 11b can be placed onto the first part portion 11a by moving the endless belt. By means of such an adjustable portioning belt 33, the time required for a portion completion can be considerably reduced since it is not necessary to merely park the first part portion 11a temporarily on the control belt 35 and to then transfer it back to the portioning belt 33 in order to complete the portion on the portioning belt 33.

FIG. 1d shows another possibility for portion completion by adjusting the portioning belt 33. Here, the portioning belt 33 can be pivoted around the rear end from the portioning position shown by dashed lines so that—as indicated by the double arrow—the front end reaches a raised position. In this inclined position, the portioning belt 33 so-to-say represents a ramp that makes it possible, at a sufficiently high speed of the endless belt, to carry out an oblique upward throw, so to speak, by means of the portioning belt 33 in order to throw the part portion 11b onto the part portion 11a, as indicated by the arrow in FIG. 1d.

The direction of travel of the portioning belt 33 is indicated by an arrow in FIGS. 1b, 1c and 1d in each case.

The aforementioned adjustment paths of the portioning belt 33 can be pure translation movements or pure pivot movements in each case. Alternatively, combined adjustment movements can also take place.

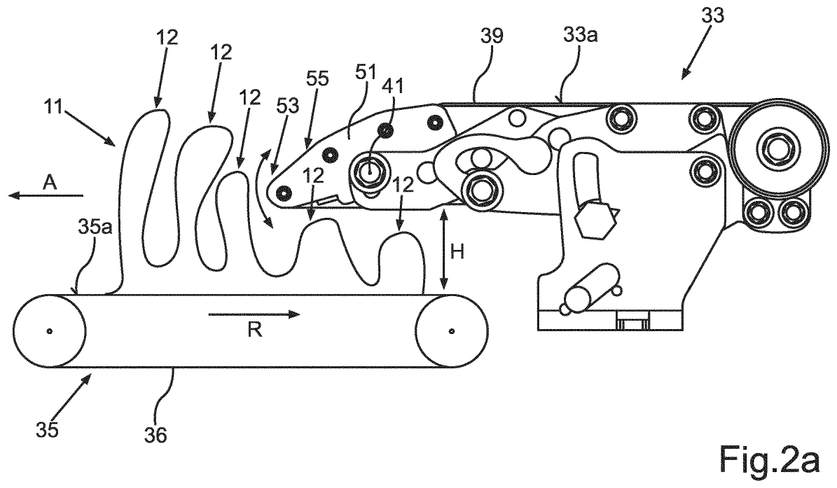

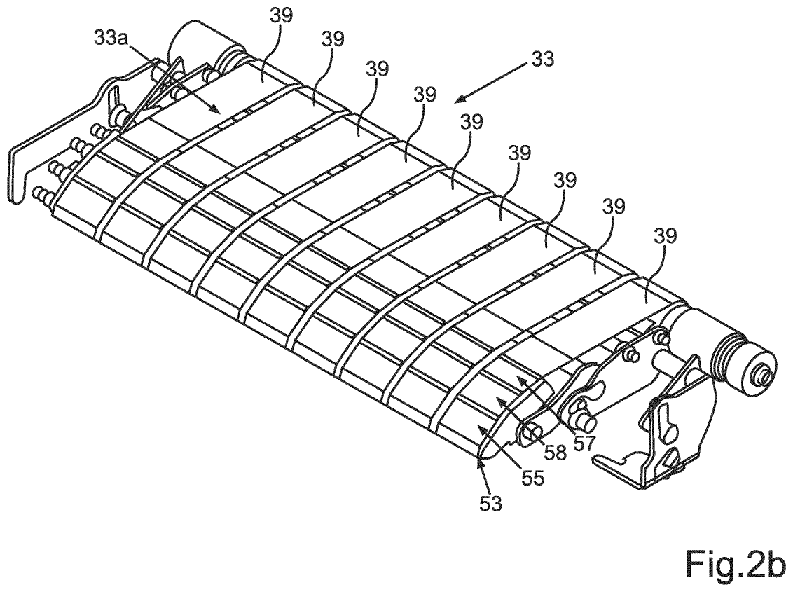

FIG. 2a shows an arrangement of the portioning unit 33 and the following unit 35, which arrangement can be used particularly advantageously for so-called “shaved” applications. The portioning unit 33 and the following unit 35 are again referred to here as a portioning belt 33 and a control belt 35, respectively. FIG. 2b only shows the portioning belt 33 in a perspective view.

The portioning belt 33 comprises an endless conveyor belt 39 that provides a horizontal portioning support 33a onto which the cut-off slices fall (cf. FIG. 1). At the front end, the portioning unit 33 has a transfer section 51 over which the conveyor belt 39 is guided and which merges into a transfer end 53 that is located at a clear height H above the support 35a of the control belt 35. By means of the transfer section 51, the conveyor belt 39 is guided such that a support surface 55 for the slices 12, which slopes down towards the support 35a of the control belt 35, is produced in front of the transfer end 53. As a result, the front end of the portioning belt 33 so-to-say forms a sloping ramp for the slices 12 that thus obliquely impact—here at an angle of approximately 45°—the horizontal following support 35a.

During the portion formation, an endless conveyor belt 36 forming the following support 35a of the control belt 35 is furthermore moved in the backward direction R that is opposite to the transporting-away direction A. This movement of the conveyor belts 36, 39 in opposite directions results in the slices 12 impacting the control belt 35 being compressed and thus rising or bulging so that a “shaved” portion 11 with a portion pattern is produced overall, such as is only schematically illustrated in FIG. 2.

Due to the backward movement of the control belt 36, a part of the portion 11 passes under the portioning belt 33. The clear height H, i.e. the intermediate space between the portioning belt 33 and the control belt 36, is dimensioned in dependence on the properties of the respective slices 12 and the desired portion pattern.

As soon as the “shaved” portion 11 has been completely formed, the control belt 35 is operated in the forward direction in order to transport the portion 11 away in the transporting-away direction A.

The transfer section 51 of the portioning belt 33 can be pivoted about an axis 41, as indicated by the double arrow in the region of the transfer end 53, in order to set the orientation of the support surface 55 relative to the control belt 35 in this way. The compression and rising and bulging behavior of the slices 12, and thus the portion pattern of the “shaved” portion, can hereby be influenced.

As FIG. 2b shows, the portioning belt 33 can have a plurality of jointly driven conveyor belts 39a that are arranged next to one another and that together form the portioning support 33a and, in so doing, a single track.

Between the horizontal portioning support 33a and the support surface 55, which merges into the transfer end 53, there are two likewise sloping surfaces 57, 58 on which a respective slice 12 to be transferred likewise rests temporarily, wherein the angle of inclination of the surfaces 57, 58 and 55 relative to the horizontal portioning support 33a increases towards the transfer end 53. The orientation of a section of a respective slice 12 that leaves the portioning belt 33 in each case, i.e. the angle at which the slice 12 leaves the portioning belt 33 or impacts the control belt 35, is determined by the angle of inclination of the support surface 55 that is disposed directly in front of the transfer end 53.

### REFERENCE NUMERAL LIST

11 portion
11a part portion
11b part portion
12 slice
12a product parts
13 food product
13a product start
13b product end
15 slicing apparatus
17 cutting blade
19 cutting plane
21 product feed
23 product support
25 product conveying device
25a conveying device
27 control device
29 scanning device
29a individual scanner
30 scanning plane
31 processor
33 portioning unit, portioning belt
33a portioning support
35 following unit, control belt
35a following support
36 endless belt
37 servo drive
39 endless belt
41 pivot axis
43 cutting edge
45 scale
47 conveyor
51 transfer section
53 transfer end
55 support surface
F conveying direction
v feed speed
A transporting-away direction
H clear height
R backward direction
PG portion weight
n number of slices
DS slice thickness
WS slice weight
G slice size
PD product data
SD control data

1. A method for forming portions that each comprise a number of n (n≥1) slices that are obtained by a single-track or multitrack slicing of loaf-shaped or strand-shaped food products using a slicing apparatus, wherein the slicing apparatus comprises:
a cutting blade that rotates and/or revolves in a cutting plane at a cutting speed measured in a number of cutting movements per unit of time,
a single-track or multitrack product feed comprising a product support and a product conveying device that is configured to feed products disposed on the product support to the cutting blade in a conveying direction at a feed speed in order to cut off slices from a respective front product end by means of the cutting blade, and
a control device that is configured to control formation of the portions based on predefined portion data,
wherein the method comprises
feeding the products using the single-track or multitrack product feed in a sequence of products directly adjoining one another,
detecting a contour and/or a structure of the products using a scanning device that is arranged upstream of the slicing apparatus and/or integrated into the slicing apparatus,
determining product data based at least in part on the contour and/or the structure for each product, such that, for a product section between two cross-sectional areas that have a spacing from one another in the conveying direction, a measure for a portion volume and/or a portion weight of the product section can be calculated from the product data,
performing a portion planning based on the product data and the predefined portion data,
wherein at least one of the portion weight, the number of n slices, a slice thickness, a slice weight, or a slice size is defined for a respective portion by the portion planning,
calculating control data for the single-track or multitrack product feed based on the portion planning, and
controlling the single-track or multitrack product feed based on the control data in order to vary the slice thickness of the slices according to the portion planning by changing the feed speed of the product conveying device, and
wherein the changing of the feed speed of the product conveying device is controlled using a computer program that, during the slicing of each product, is executed without a program change for an entire product, including a product start and a product end, in a processor of the control device.

2. A method according to claim 1,
wherein detecting the contour and/or the structure when viewed in the conveying direction, takes place at a first spacing from the cutting plane that is smaller than a product length of a product but greater than the slice thickness, and/or
wherein detecting the contour and/or the structure when viewed in the conveying direction, takes place at a second spacing from the cutting plane that is greater than the product length.

3. A method according to claim 1,
wherein transitions between two directly consecutive products are considered during the portion planning such that a respective portion comprises slices from two directly consecutive products,
wherein the transitions comprise the product end and the product start.

4. A method according to claim 1,
wherein, during the portion planning, a distinction is made between usable slices and unusable product parts based on the predefined portion data and unusable product parts are excluded from the formation of a portion.

5. A method according to claim 1,
wherein the single-track or multitrack product feed is stopped to interrupt the cutting off of slices, and/or
wherein, immediately before a stopping and/or immediately after a restarting of the single-track or multitrack product feed, another compensating product push takes place, the restarting taking place subsequent to the stopping.

6. A method according to claim 1,
wherein a portioning support, which is arranged downstream of the cutting blade and onto which the slices fall, is adjustable between at least one portioning position and at least one ejection position in order to eject unusable product parts

7. A method according to claim 1,
wherein a portioning support, which is arranged downstream of the cutting blade and onto which the slices fall, is adjustable in order to carry out a portion completion in that a first part portion is first formed on the portioning support and the first part portion is then transferred to a following unit arranged downstream, thereupon unusable product parts falling onto the portioning support are ejected, and subsequently a second part portion is formed on the portioning support and the second part portion is then placed onto the first part portion by the portioning support to form a completed total portion from the first part portion and the second part portion.

8. A method according to claim 6,
wherein the portioning support is adjusted using a servo drive.

9. A method according to claim 1,
wherein the portion planning takes place such that the slices of a respective portion all have at least approximately the same slice thickness.

10. A method according to claim 1,
wherein the portion planning takes place such that k (k≥1) last or first portions of a respective product each have a portion weight that is reduced or increased compared to other portions of the respective product.

11. A method according to claim 1,
wherein an average value or an individual value for a product density is determined for each of the products, and
wherein the product density is considered when determining the product data.

12. A slicing apparatus for slicing loaf-shaped or strand-shaped food products, said slicing apparatus comprising:
a cutting blade that rotates and/or revolves in a cutting plane at a cutting speed measured in a number of cutting movements per unit of time,
a single-track or multi-track product feed comprising a product support and a product conveying device that is configured to feed products disposed on the product support to the cutting blade in a conveying direction at a feed speed in order to cut off slices from a respective front product end by means of the cutting blade, and
a control device that is configured to control the slicing of the products by carrying out actions, comprising:
feeding the products using the single-track or multi-track product feed in a sequence of products directly adjoining one another,
detecting a contour and/or a structure of the products using a scanning device that is arranged upstream of the slicing apparatus and/or integrated into the slicing apparatus,
determining product data based at least in part on the contour and/or the structure for each product, such that, for each product section between two cross-sectional areas that have a spacing from one another in the conveying direction, a measure for a portion volume and/or a portion weight of this product section can be calculated from the product data,
performing a portion planning based on the product data and predefined portion data,
wherein at least one of the portion weight, the number of slices, a slice thickness, a slice weight, or a slice size are defined for a respective portion by the portion planning,
calculating control data for the single-track or multi-track product feed based on the portion planning, and
controlling the single-track or multi-track product feed based on the control data to vary the slice thickness of the slices according to the portion planning by changing the feed speed of the product conveying device, and
wherein changing the feed speed of the product conveying device is controlled using a computer program that, during the slicing of each product, is executed without a program change for an entire product, including a product start and a product end, in a processor of the control device.

13. A slicing apparatus according to claim 12,
wherein the slicing apparatus has an integrated scanning device for detecting the contour and/or the structure of the products, and/or
wherein the control device is configured to receive information relating to the contour and/or the structure of the products from an external scanning device and to process said information.

14. A slicing apparatus according to claim 13,
wherein the scanning device for detecting the contour of the products operates in accordance with a light sectioning method, and/or
wherein the scanning device comprises a plurality of individual scanners arranged around the product support.

15. A slicing apparatus according to claim claim 12,
wherein the product conveying device has one or more conveying devices laterally engaging at the products.

16. A slicing apparatus according to claim claim 12,
wherein the slicing apparatus comprises a portioning unit having a portioning support and a following unit that is arranged downstream of the portioning unit and that has a following support to which the portioning unit transfers the slices,
wherein the portioning unit is adjustable during operation such that the portioning support can be adjusted between at least two positions that differ from one another with respect to an orientation of the portioning support relative to the following support of the following unit.

17. A slicing apparatus for slicing loaf-shaped or strand-shaped food products, said slicing apparatus comprising:
a cutting blade that rotates and/or revolves in a cutting plane at a cutting speed measured in a number of cutting movements per unit of time,
a single-track or multi-track product feed comprising a product support and a product conveying device that is configured to feed products disposed on the product support to the cutting blade in a conveying direction in order to cut off slices from a respective front product end by of the cutting blade,
a portioning unit that has a portioning support onto which the slices cut off by the cutting blade fall, and
a following unit that is arranged downstream of the portioning unit and that has a following support to which the portioning unit transfers the slices and which can be moved in a transporting-away direction that is directed away from the portioning unit in order to transport away portions formed on the portioning support and/or on the following support,
wherein the portioning unit is adjustable during operation between at least two positions that differ from one another with respect to an orientation of the portioning support relative to the following support of the following unit, or
wherein a portion formation from slices transferred after one another by the portioning unit takes place on the following support, wherein the portioning unit has a transfer section that merges into a transfer end disposed above the following support and that forms a support surface for the slices in front of the transfer end, said support surface sloping down towards the following support.

18. A slicing apparatus according to claim 17,
wherein the following support extends opposite to the transporting-away direction beyond the transfer end of the portioning unit below the portioning unit, wherein the following support can at least temporarily be moved opposite to the transporting-away direction during the portion formation, and
wherein a clear height at least for a part of a respective portion is present between the portioning unit and a section of the following support that extends below the portioning unit.

18. A slicing apparatus according to claim 17,
wherein a course of the support surface of the transfer section can be adjusted relative to the following support of the following unit during the operation and/or for adaptation to a respective application.

19. A slicing apparatus according to claim 17,
wherein the slicing apparatus furthermore comprises a control device that is configured to perform the slicing of the products by carrying out actions, comprising:
feeding the products using the single-track or multi-track product feed in a sequence of products directly adjoining one another,
detecting a contour and/or a structure of the products using a scanning device that is arranged upstream of the slicing apparatus and/or integrated into the slicing apparatus,
determining product data based at least in part on the contour and/or the structure for each product, such that, for each product section between two cross-sectional areas that have a spacing from one another in the conveying direction, a measure for a portion volume and/or a portion weight of this product section can be calculated from the product data,
performing a portion planning based on the product data and predefined portion data, wherein at least one of the portion weight, the number of slices, a slice thickness, a slice weight, or a slice size are defined for a respective portion by the portion planning,
calculating control data for the single-track or multi-track product feed based on the portion planning, and
controlling the single-track or multi-track product feed based on the control data to vary the slice thickness of the slices according to the portion planning by changing a feed speed of the product conveying device, and
wherein changing the feed speed of the product conveying device is controlled using a computer program that, during the slicing of each product, is executed without a program change for an entire product, including a product start and a product end, in a processor of the control device.

21. A method for forming shaved meat portions or shaved cheese portions that each comprise a number of n (n>1) slices that are obtained by a single-track or multitrack slicing of loaf-shaped or strand-shaped food products using a slicing apparatus,
wherein the slices successively reach a first support and, by moving the first support, are transferred to a moving second support disposed below the first support, wherein the first support and the moving second support overlap one another and move in opposite directions.

22. A method for forming shaved meat portions or shaved cheese portions that each comprise a number of n (n>1) slices that are obtained by a single-track or multitrack slicing of loaf-shaped or strand-shaped food products using a slicing apparatus,
wherein the slicing apparatus comprises:
a cutting blade that rotates and/or revolves in a cutting plane at a cutting speed measured in a number of cutting movements per unit of time,
a single-track or multitrack product feed comprising a product support and a product conveying device that is configured to feed products disposed on the product support to the cutting blade a conveying direction in order to cut off slices from a respective front product end by means of the cutting blade,
a portioning unit, that has a portioning support onto which the slices cut off by the cutting blade fall, and
a following unit that is arranged downstream of the portioning unit and that has a following support to which the portioning unit transfers the slices and which can be moved in a transporting-away direction directed away from the portioning unit in order to transport away portions formed on the portioning support and/or on the following support,
wherein:
the following support extends opposite to the transporting-away direction beyond a transfer end of the portioning unit below the portioning unit and a clear height at least for a part of a respective portion is present between the portioning unit and a section of the following support that extends below the portioning unit,
wherein the portions are each formed in that the following support is moved opposite to the transporting-away direction while the slices are transferred from the portioning unit to the following support.

23. A method according to claim 22,
wherein the slices are moved obliquely downwardly towards the following support during the transfer by the portioning unit.

24. A method according to claim 22, wherein the portioning unit has a transfer section that merges into the transfer end disposed above the following support and that forms a support surface for the slices in front of the transfer end, said support surface sloping down towards the following support.

25. A method according to claim 21, wherein the slices are moved obliquely downwardly towards the second support during the transfer.
